(19) United States
(12) Patent Application Publication
(10) Pub. No.: US 2023/0360403 A1
(43) Pub. Date: Nov. 9, 2023

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Kenji Fukuda, Tokyo (JP); Naoki Sawada, Tokyo (JP); Yuri Satou, Tokyo (JP)

(73) Assignee: NEC Corporation, Minato-ku, Tokyo (JP)

(21) Appl. No.: 18/029,610

(22) PCT Filed: Oct. 9, 2020
(86) PCT No.: PCT/JP2020/038313

§ 371 Date: Mar. 30, 2023

(51) Int. Cl. G06V 20/52; G06V 40/20; H04N 7/18

(52) U.S. Cl. CPC G06V 20/52; G06V 40/20; H04N 7/181

(57) ABSTRACT

The information processing device includes an image acquisition means, an information acquisition means, and a messaging means. The image acquisition means acquires an image capturing a target animal. The information acquisition means acquires information related to a state of the target animal. Then, the messaging means transmits an image capturing the state of the target animal when the state of the target animal satisfies a predetermined image transmission condition, based on the image and the information.

### TECHNICAL FIELD

The present invention relates to a technique for transmitting images related to animals.

### BACKGROUND ART

There has been proposed a method of obtaining information on the state of a pet and transmitting the information to the terminal device of the owner when the owner is absent. For example, Patent Document 1 discloses a device which determines the behavior event of the pet from the moving image capturing the pet, and notifies it to the communication terminal of the user when a specific behavior event is detected. Further, Patent Document 2 discloses a system in which the condition of the pet is detected by a sensor terminal, utterance data of a first person is generated on the basis of detected data, and conversation with the owner or other user is performed using an interactive SNS.

### PRECEDING TECHNICAL REFERENCES

### Patent Document

Patent Document 1: Japanese Patent Application Laid-Open under No. JP 2009-182400
Patent Document 2: International Publication WO2016/125478

### SUMMARY

### Problem to be Solved by the Invention

In the above patent documents, it is difficult to grasp the state of the pet in many aspects.

One object of the present invention is to provide an information processing device capable of grasping the state of the pet in many aspects.

### Means for Solving the Problem

According to an example aspect of the present invention, there is provided an information processing device comprising:
an image acquisition means configured to acquire an image capturing a target animal;
an information acquisition means configured to acquire information related to a state of the target animal; and
a messaging means configured to transmit an image capturing the state of the target animal when the state of the target animal satisfies a predetermined image transmission condition, based on the image and the information.

According to another example aspect of the present invention, there is provided an information processing method comprising:
acquiring an image capturing a target animal;
acquiring information related to a state of the target animal; and
transmitting an image capturing the state of the target animal when the state of the target animal satisfies a predetermined image transmission condition, based on the image and the information.

According to still another example aspect of the present invention, there is provided a recording medium recording a program, the program causing a computer to execute processing comprising:
acquiring an image capturing a target animal;
acquiring information related to a state of the target animal; and
transmitting an image capturing the state of the target animal when the state of the target animal satisfies a predetermined image transmission condition, based on the image and the information.

### BRIEF DESCRIPTION OF THE DRAWINGS

FIG. 1 shows an overall configuration of a communication system to which an information processing device is applied.

FIG. 2 shows an example of a floor plan of home of an owner.

FIG. 3 is a block diagram showing a configuration of a home system.

FIG. 4 is a block diagram showing a configuration of a pet terminal.

FIGS. 5A and 5B are block diagrams showing configurations of a server and a user terminal.

FIG. 6 is a flowchart of image transmission processing.

FIG. 7 shows an example of displaying images transmitted by the image transmission processing.

FIG. 8 is a block diagram showing a functional configuration of an information processing device of a fourth example embodiment.

FIG. 9 is a flowchart of processing by the information processing device of the fourth example embodiment.

### EXAMPLE EMBODIMENTS

### First Example Embodiment

[Overall Configuration]

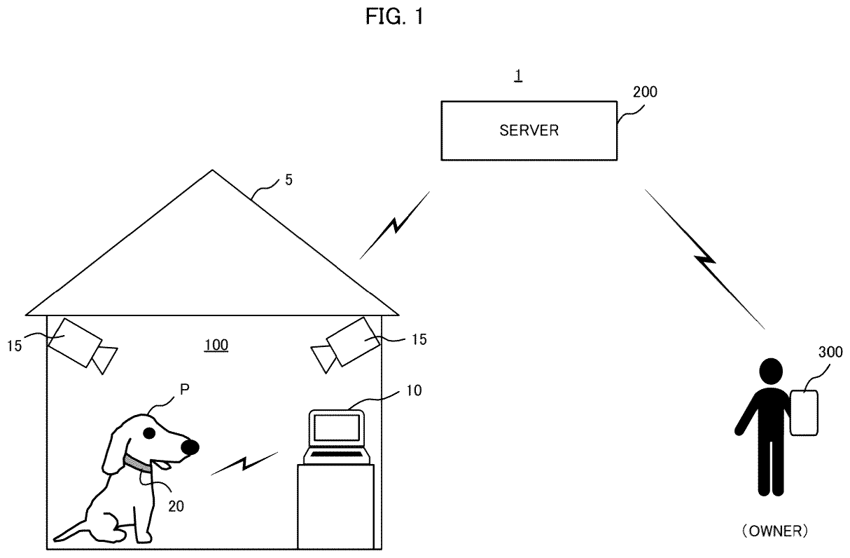

FIG. 1 shows an overall configuration of a communication system to which an information processing device according to the present disclosure is applied. The communication system 1 includes a home system 100 installed in the home 5 of the owner of the pet, a server 200, and a user terminal 300 used by the owner. The pet P is staying at the home 5 of the owner, and a pet terminal 20 is attached to the pet P. Further, fixed cameras 15 are installed in predetermined locations in the home 5. The home system 100 and the server 200 can communicate by wired or wireless communication. The server 200 can also communicate wirelessly with the user terminal 300 of the owner.

As a basic operation, the home system 100 generates message information about the pet P based on the location and behavior of the pet P (hereinafter referred to as the “state of the pet P”), and transmits the message information to the user terminal 300 of the owner via an interactive SNS (Social Network Service). Here, the message information includes a text message, a stamp, and the like. When the state of the pet P satisfies a predetermined condition (hereinafter referred to as the “message information transmission condition”), the server 200 transmits the message information, such as a text message and/or a stamp prepared beforehand in correspondence with the condition, to the user terminal 300 of the owner using the interactive SNS. Thus, the owner can receive the message information according to the state of the pet P and grasp the state of the pet.

The message information generated may be based on the behavior, location, and state of Pet P. The trigger for transmitting the message information is not particularly limited as long as it relates to the behavior, location, and state of the pet P. For example, the message information may be transmitted based on the request of the owner. It is also possible to perform interactive conversation such that the owner sends the image or message to the pet P and the pet P returns the image or message or stamp to the owner. For example, when the owner sends the message “Did you have a meal?”, the Pet P returns the image of the rice and the stamp.

Further, in the present example embodiment, the server 200 transmits the captured image of the pet P to the user terminal 300 of the owner. Specifically, when the state of the pet P satisfies a predetermined condition (hereinafter, referred to as “image transmission condition”), the server 200 transmits the image of the pet P captured at that time to the user terminal 300 of the owner via the interactive SNS. In this case, the captured image of the pet P may be an image capturing the pet P, or may be an image of the pet′ view taken by a camera attached to the pet P as described later. The owner can see the actual state of the pet P by viewing the image of the pet P transmitted to the user terminal 300.

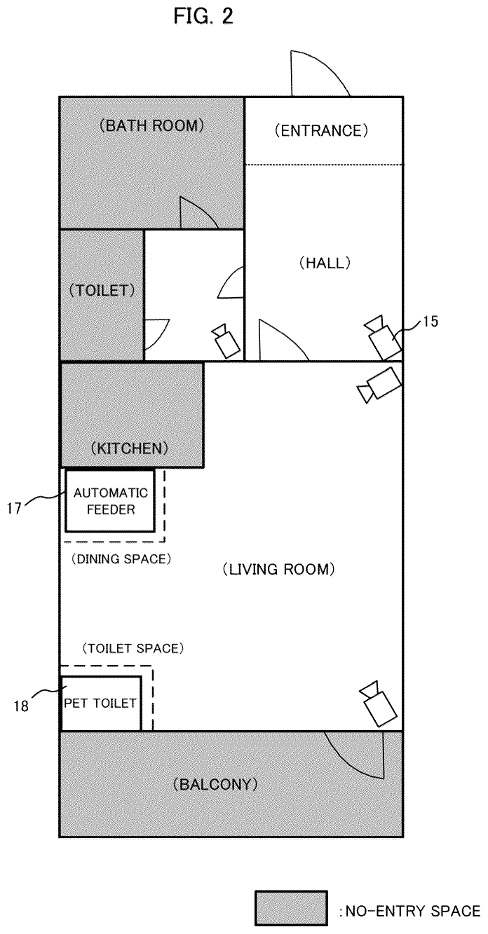

FIG. 2 shows an example of a floor plan of the owner's home 5. The home has an entrance, hall, bathroom, toilet, living room, kitchen, balcony, etc. The door partitioning each space is basically open, and the pet can move each space freely. In each space, a fixed camera 15 for capturing the state of the pet P is installed. Some of the spaces in the home 5 are decided to be the spaces where the pet P should not enter (hereinafter referred to as “no-entry spaces”). The no-entry spaces include a space to which the entry is not allowed because it is dangerous for the pet P, and a space to which the entry is not allowed because the pet P may do mischief. In the example of FIG. 2, the bathroom, toilet, kitchen, and balcony shown in gray color are determined as the no-entry spaces.

[Home System]

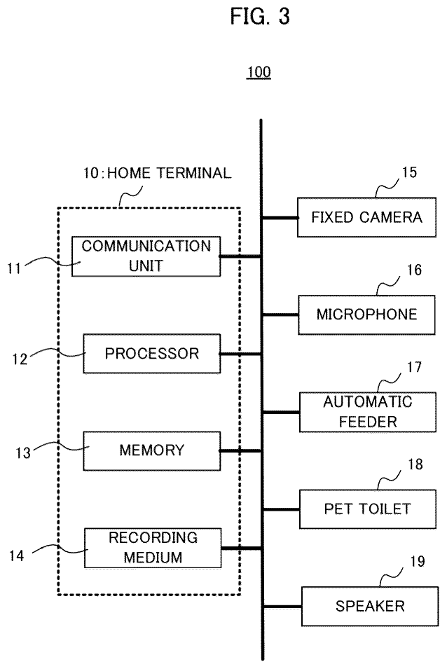

FIG. 3 is a block diagram showing the configuration of the home system 100 installed in the home 5. In the example of FIG. 3, the home system 100 includes a home terminal 10, fixed cameras 15, a microphone 16, an automatic feeder 17, a pet toilet 18, and a speaker 19. However, the home system 100 may include, not all of the above-described elements, but some of them. The home terminal 10 is, for example, a terminal device such as a PC, a tablet, or a smartphone, and includes a communication unit 11, a processor 12, a memory 13, and a recording medium 14.

The communication unit 11 communicates with an external device. Specifically, the communication unit 11 wirelessly communicates with the pet terminal 20 attached to the pet P by Bluetooth (registered trademark), for example. The communication unit 11 communicates with the server 200 in a wired or wireless manner.

The processor 12 is a computer such as a CPU (Central Processing Unit) and controls the entire home terminal 10 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 executes image transmission processing described later by executing a program prepared in advance.

The memory 13 may be a ROM (Read Only Memory) and a RAM (Random Access Memory). The memory 13 stores various programs executed by the processor 12. The memory 13 is also used as a working memory during various processes performed by the processor 12.

The recording medium 14 is a non-volatile and non-transitory recording medium such as a disk-like recording medium and a semiconductor memory, and is configured to be detachable from the home terminal 10. The recording medium 14 records various programs executed by the processor 12. When the home terminal 10 transmits information and images related to the pet P to the server 200, the program recorded on the recording medium 14 is loaded into the memory 13 and executed by the processor 12. The images captured by the fixed cameras 15, the sound collected by the microphone 16, information received from the pet terminal 20, and the like are temporarily stored in the memory 13.

The fixed cameras 15 are installed at predetermined positions in the home 5. Basically, the necessary number of fixed cameras 15 are installed so as to cover the entire spaces in which the pet P can move. In particular, the fixed cameras 15 are installed at the positions to shoot the images of the areas including the no-entry spaces of the pet P. The fixed cameras 15 are always operating to shoot a video of the shooting range, and transmit the video the home terminal 10.

The microphone 16 is installed in each space of the home 5. The microphone 16 may be integrated with the fixed camera 15. The microphone 16 collects the sound generated in each space, and transmits the sound to the home terminal 10. The home terminal 10 transmits the sound collected by the microphone 16 to the server 200.

The automatic feeder 17 is provided in the dining space in the living room as shown in FIG. 2. The automatic feeder 17 is a device to feed the pet P when the owner is absent. For example, the automatic feeder 17 automatically supplies the feed to the dish for pet at a time set in advance, and transmits a notice indicating that the feed was given to the pet P to the home terminal 10. The home terminal 10 transmits the notice from the automatic feeder 17 to the server 200. The home terminal 10 also transmits, to the server 200, the image captured by the fixed camera around the time of receiving the notice.

The pet toilet 18 is installed in the toilet space in the living room as shown in FIG. 2. The pet toilet 18 includes, for example, a water absorbing sheet and a sensor, detects excretion of the pet P, and sends a notice to the home terminal 10. The home terminal 10 transmits the notice from the pet toilet 18 to the server 200. The home terminal 10 also transmits, to the server 200, the image captured by the fixed camera 15 around the time of receiving the notice.

The speaker 19 is installed in the living room or the no-entry space of the home 5, and outputs a warning sound and a message for the pet P. For example, by recording a scolding voice of the owner (“Don't enter there!”) in advance, the same voice can be outputted to the pet when the pet P enters the no-entry space, even when the owner is not present.

[Pet Terminal]

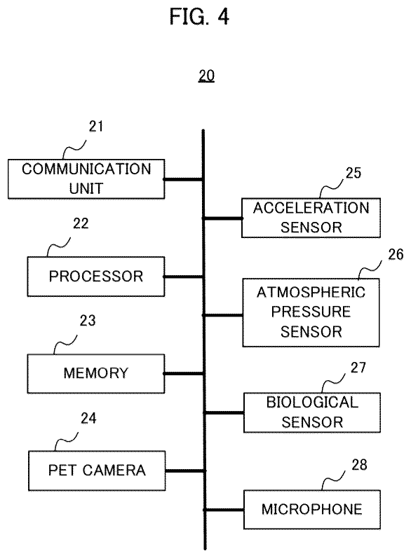

FIG. 4 is a block diagram showing the configuration of the pet terminal 20 attached to the pet P. The pet terminal 20 may be attached to the pet instead of the collar of the pet P or attached to the collar that the pet is wearing, for example. The pet terminal 20 includes a communication unit 21, a processor 22, a memory 23, a pet camera 24, an acceleration sensor 25, an atmospheric pressure sensor 26, a biological sensor 27, and a microphone 28.

The communication unit 21 communicates with an external device. Specifically, the communication unit 21 wirelessly communicates with the home terminal 10 by, for example, Wi-Fi (registered trademark) or Bluetooth (registered trademark).

The processor 22 is a computer, such as a CPU, that controls the entire pet terminal 20 by executing a predetermined program. The processor 12 periodically transmits the information acquired by each sensor to the home terminal 10 by executing a program prepared in advance.

The memory 23 is configured by a ROM, RAM or the like. The memory 23 stores various programs executed by the processor 22. The memory 23 is also used as working memory during various processes executed by the processor 22. Furthermore, the memory 23 temporarily stores information detected by each sensor.

The pet camera 24 is a camera for shooting the image of the pet′ view. The pet camera 24 may be configured to detect the orientation of the neck of the pet P to determine the shooting direction, may be mounted near the head of the pet P, or may be a camera that shoots the front of the pet P at a wide angle. The pet camera 24 shoots an area including the viewing direction of the pet P and transmits the shot image to the home terminal 10. Thus, the home terminal 10 can acquire the image of the pet's view.

The acceleration sensor 25 is a three-axis acceleration sensor, which measures the motion of the pet P in the three-axis direction and transmits it to the home terminal 10. Based on the output of the acceleration sensor 25, the home terminal 10 can estimate the activity amount of the pet P or the like. The atmospheric pressure sensor 26 measures the atmospheric pressure at the place of the pet P and transmits it to the home terminal 10. Based on the output of the atmospheric pressure sensor 26, the home terminal 10 can detect the vertical movement of the pet P, e.g., a jump. Further, although not shown in FIG. 4, a gyro sensor may be used. A six-axis sensor in which a three-axis acceleration sensor and a three-axis gyro sensor (a three-axis angular velocity sensor) are integrated may be used. The sensor is not limited to the above-described one as long as the sensor can measure the activity amount of the animal.

The biological sensor 27 is a sensor for measuring the biological information of the pet P. For example, the biological sensor 27 measures the body temperature, the heart rate and the respiration rate of the pet P, and transmits them to the home terminal 10. The home terminal 10 transmits the acquired biological information to the server 200.

The microphone 28 collects the sound around the pet P and transmits the sound to the home terminal 10. The home terminal 10 transmits the sound to the server 200. The server 200 can estimate the motion state, the mental state, or the like of the pet based on the sound of the pet P running around or the breath sound, for example.

[Server]

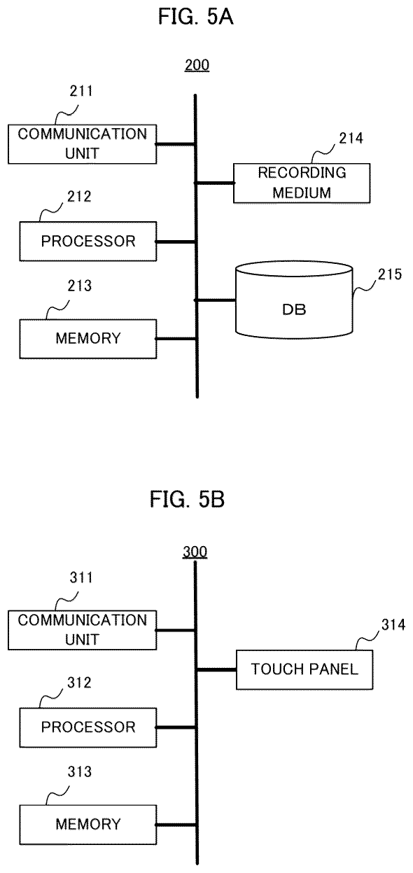

FIG. 5A is a block diagram illustrating the configuration of the server 200. The server 200 transmits messages to and receives messages from the user terminal 300 by the interactive SNS. The server 200 includes a communication unit 211, a processor 212, a memory 213, a recording medium 214, and a database 215.

The communication unit 211 transmits and receives data to and from an external device. Specifically, the communication unit 211 transmits and receives information to and from the home terminal 10 and the user terminal 300 of the owner.

The processor 212 is a computer, such as a CPU, that controls the entire servers 200 by executing a program prepared in advance. The processor 212 may be a GPU, a FPGA, a DSP, an ASIC or the like. Specifically, the processor 212 transmits message information and images to the owner's user terminal 300.

The memory 213 is configured by a ROM, RAM, or the like. The memory 213 is also used as a working memory during various processes by the processor 212. The recording medium 214 is a non-volatile non-transitory recording medium such as a disk-like recording medium or a semiconductor memory and is configured to be detachable from the server 200. The recording medium 214 records various programs executed by the processor 212.

The database 215 stores information and images received from the home terminal 10 through the communication unit 211. That is, message information and images transmitted and received by users of a plurality terminals including the home terminal 10 and the user terminal 300 are stored in the database 215. Further, the database 215 stores, for each user, the transmission condition of the message information, and the message information prepared in advance for each transmission condition (e.g., a predetermined message, stamp, etc.). The server 200 may include a keyboard, an input unit such as a mouse, and a display unit such as a liquid crystal display to allow an administrator to give instructions or input.

[User Terminal]

FIG. 5B is a block diagram illustrating an internal configuration of the user terminal 300 used by the owner. The user terminal 300 is, for example, a smartphone, a tablet, a PC, or the like. The user terminal 300 includes a communication unit 311, a processor 312, a memory 313, and a touch panel 314.

The communication unit 311 transmits and receives data to and from the external device. Specifically, the communication unit 311 transmits and receives information to and from the server 200.

The processor 312 is a computer, such as a CPU, and controls the entire user terminal 300 by executing a program prepared in advance. The processor 312 may be a GPU, a FPGA, a DSP, an ASIC or the like. Specifically, the user terminal 300 is installed with a messaging application for the interactive SNS executed by the server 200. The “messaging application” is an application that provide exchange of information such as text messages, stamps, and images. The processor 312 receives the transmitted message information and images through the server 200 by the messaging application and displays them on the touch panel 314. The processor 312 also transmits message information entered by the owner to the server 200 through the messaging application.

The memory 313 is configured by a ROM and a RAM. The memory 313 is also used as a working memory during various processing by the processor 312. The touch panel 314 displays the message information received by the user terminal 300. The touch panel 314 also functions as an input device of a user.

[Image Transmission]

Next, image transmission to the user terminal 300 of the owner will be described.

(Image Transmission Condition)

The server 200 determines the state of the pet P in the home 5 based on various information transmitted from the home terminal 10, and transmits the image of the pet P to the user terminal 300 of the owner by the interactive SNS when the state of the pet P satisfies a predetermined image transmission condition. Here, it is assumed that the “state” of the pet P includes the place where the pet P is present, the behavior of the pet P, and the biological state of the pet P (a health state such as fever and insufficient moisture, emotions, and a mental state such as an excited state and a depressed state). Hereinafter, specific examples of the image transmission condition will be described.

(1) Condition Related to the Location of the Pet P

(A) Dining Space

The image transmission condition may include that the pet P has entered the dining space. The home terminal 10 detects that the pet P has entered the dining space on the basis of the output signal of the automatic feeder 17, and notifies the server 200. The server 200 transmits, to the user terminal 300, the image of the pet P when the pet P enters the dining space illustrated in FIG. 2. Since the automatic feeder 17 does not operate at the time other than a predetermined meal time, the server 200 may determine that the pet P has entered the dining space by analyzing the captured images of the fixed cameras 15 and the pet camera 24 transmitted from the home terminal 10. Further, a human detection sensor may be installed in the dining space, and the approach of the pet P may be detected by the human detection sensor to notify the server 200. This allows the owner to receive the image that the pet P entered the dining space at the meal time and to see how the pet P is eating. In addition, if owner receives such an image that the pat P entered the dining space other than the meal time, the owner can guess that the pet P may be hungry.

In addition to the fact that the pet P has entered the dining space, the stay time in the dining space may be included in the image transmission condition. That is, the image transmission condition may be that the pet P has stayed in the dining space for a predetermined time or more. In addition, the time zone when the pet P entered or stayed in the dining space may be included in the image transmission condition. For example, the image transmission condition may be that the pet P entered or stayed in the dining space in a predetermined time zone.

The server 200 can acquire the image when the pet P is eating from the image captured by the fixed cameras 15 or the pet camera 24 near the time when the pet P enters or stays in the dining space.

(B) Toilet Space

The image transmission condition may include that the pet P has entered the toilet space. The home terminal 10 detects that the pet P has entered the toilet space based on the output signal of the pet toilet 18 and notifies the server 200. The server 200 transmits the image of the pet P to the user terminal 300 when the pet P enters the toilet space illustrated in FIG. 2. The server 200 may analyze the captured images of the fixed cameras 15 or the pet camera 24 transmitted from the home terminal 10 to determine that the pet P has entered the toilet space. Further, a human detection sensor may be installed in the toilet space, and the entry of the pet P to the toilet space may be detected based on the output of the human detection sensor to notify the server 200.

In addition to the fact that the pet P has entered the toilet space, the stay time at the toilet space may be included in the image transmission condition. That is, the image transmission condition may be that the pet P stays in the toilet space for a predetermined time or more. In addition, the time zone during which the pet P entered or stayed in the toilet space may be included in the image transmission condition. For example, the image transmission condition may be that the pet P has entered or stayed in the toilet space in a predetermined time zone.

The server 200 can acquire the image when the pet P is excreting or the image of the excretion from the images captured by the fixed cameras 15 or the pet camera 24 near the time when the pet P enters the toilet space or stays there.

(C) No-Entry Space

The image transmission condition may include that the pet P has entered the no-entry space. The server 200 can determine that the pet P has entered the no-entry space by analyzing the captured images of the fixed cameras 15 or the pet camera 24. When the server 200 determines that the pet P has entered the no-entry space shown in gray color in FIG. 2, the server 200 transmits the image of the pet P to the user terminal 300. In addition, a human detection sensor that uses infrared rays or the like may be installed in the no-entry space, and the entry of the pet P may be detected based on the output of the human detection sensor to notify the server 200. The method of detecting the entry of the pet P may be different for each individual no-entry space. This allows the owner to see the image showing the pet P entering the space where the pet P should not enter.

In addition to the fact that the pet P has entered the no-entry space, the stay time in the no-entry space may be included in the image transmission condition. That is, the image transmission condition may be that the pet P has stayed in the no-entry space for a predetermined time or more. In addition, the time zone during which the pet P entered or stayed in the no-entry space may be included in the image transmission condition. For example, the image transmission condition may be that the pet P has entered or stayed in the no-entry space in a predetermined time zone.

The server 200 can acquire the image when the pet P is in the no-entry space from the images captured by the fixed cameras 15 or the pet camera 24 near the time when the pet P has entered or stays in the no-entry space.

(D) Other Place

The image transmission condition may include the fact that the pet P has entered a predetermined place other than the above, or the fact that the pet P has stayed in the place for a predetermined time or more. For example, if there is a habit in the pet P to wait for the owner to return home at the entrance, the server 200 may transmit the image of the pet P to the user terminal 300 when the pet P is at the entrance. In this case, the image transmission condition may be that the pet P simply comes to the entrance. Instead, the image transmission condition may be that the pet P has come to the entrance repeatedly more than a predetermined number of times, or stays at the entrance for a predetermined time or more. When the average coming-home time of the owner (e.g., 17:00 to 19:00) is set, the image transmission condition may be that the pet P has come to the entrance in the time zone, that the pet P has come to the entrance more than a predetermined number of times, or that the pet P stays at the entrance for a predetermined time or more. The server 200 can determine that the pet P is at the entrance by analyzing the captured images of the fixed cameras 15 or the pet camera 24. In addition, a human detection sensor that uses infrared rays or the like may be installed in the entrance, and the fact that the pet P is staying in the entrance may be detected based on the output of the human detection sensor to notify the server 200. This allows the owner to see the image that the pet P is waiting for the owner to come home.

In addition to the above example, when there is a place where the pet P prefers to stay based on the trait and habit of the pet P, the image transmission condition may be that the pet P comes to the place or stays there. For example, if the pet P likes a sunny place on a sofa or near a balcony, and has a habit of spending a long time of the day at the place, the image transmission condition may be that the pet P has stayed at the place for a predetermined time or more. The owner can see how the pet is relaxing from the received image. Incidentally, when the image transmission condition is that the pet P has come to a place where the pet P stays for a long time as described above, the server 200 may transmit the image periodically at predetermined time intervals, or randomly for multiple times, while the pet P stays at the place.

(2) Condition Related to Behavior of Pet P

The image transmission condition may include that the pet P has done a specific behavior. For example, the image transmission condition may be that the pet P runs in a room, barks with a loud voice, moans, or vomits. The server 200 analyzes at least one of the output signal from the pet terminal 20 mounted on the pet P and the captured images of the fixed cameras 15 or the pet camera 24 to determine that the pet P is doing the specific behavior described above.

(3) Condition Related to the State of the Pet P

The image transmission condition may include the condition related to the state of the pet P. That is, when the pet P satisfies a predetermined condition, the image may be transmitted. Specifically, the server 200 can estimate the physical condition of the pet P (illness or poor physical condition such as fever or overbreathing, etc.) or the mental condition (excited state, settled state, stressed state, etc.) of the pet P using the biological information detected by the pet terminal 20. Also, the server 200 analyzes the sound collected by the microphone 16 of the home and determines whether or not the sound corresponds to a specific sound. For example, by registering in advance various crying voices of the pet P (barking voice, low voices when threatening the other party, sad voice, sweet voice, etc.), it is possible to distinguish and judge the crying voices of the pet P and estimate the state of the pet P. Therefore, when the server 200 determines that the pet P satisfies the preset condition, the server 200 transmits the image when the pet P corresponds to the predetermined state from the images captured by the fixed cameras 15 or the pet camera 24 around the time. The owner can know whether the pet P is in an excited state or in poor condition or else by looking at the received image.

(4) Condition Related to the Messages Received from the Owner

The image transmission condition may include the condition related to the message received from the owner's user terminal 300. For example, when the server 200 receives a message including predetermined words from the user terminal 300 of the owner, the server 200 may transmit a corresponding image. For example, the server 200 receives a message “Did you have lunch?”, “You ate a lot” or the like related to the meal from the owner, the server 200 may transmit the image of the meal of the pet P or the like to the owner's user terminal 300.

(Setting Image Transmission Conditions)

The owner can select any of the above image transmission conditions and set it on the server 200. That is, the user terminal 300 can set a desired image transmission condition by receiving a selection operation of the image transmission condition from the owner. For example, the owner may operate the home terminal to set the bathroom and kitchen as the no-entry space, set the entrance and sofa as other places, and set the behavior of crying loudly as the behavior of the pet P.

In addition, the owner can set the state of the pet P that was not set as the image transmission condition as the message information transmission condition. That is, the owner can set to send only a message, without sending an image, if the pet P becomes a particular state. Then, the home terminal 10 transmits message information such as a text message or a stamp preset for the condition when the state of the pet P satisfies the message information transmission condition. For example, the message information transmission condition may be set to send a prepared text message “I had lunch.” instead of sending an image when the pet P had lunch.

Further, the state of the pet P may be set to both the image transmission condition and the message information transmission condition. In this case, if the state of the pet P satisfies both the image transmission condition and the message information transmission condition, both the message information such as a text message and a stamp corresponding to the state and the image captured from the state are transmitted to the user terminal 300 of the owner. For example, when the pet P eats lunch, a text message saying “I had lunch” and an image of the pet P during eating are both transmitted to the user terminal 300.

(Setting Image to be Transmitted)

Next, the image to be transmitted to the user terminal 300 of the owner will be described. When the state of the pet P satisfies the image transmission condition described above, the server 200 transmits the captured image of the pet P at that time to the user terminal 300. Here, the image to be transmitted may be the captured image of the fixed camera 15 installed in a plurality of locations of the home 5, or the captured image of the pet camera 24 attached to the pet P. The captured image of the fixed camera 15 is the image obtained by capturing the pet P from a third party's view, and corresponds to a scene that the owner would see when the owner is in his or her home 5. On the other hand, since the captured image of the pet camera 24 is the image of the pet's view, the owner can guess the state and feeling of the pet at that time. The server 200 transmits one or both of the captured image of the fixed camera and the captured image of the pet camera 24 to the user terminal 300 according to the setting of the owner.

The image to be transmitted to the user terminal 300 may be a still image, a GIF (Graphics Interchange Format) image or a movie of about a few seconds. In the case of the still image, when the home terminal 10 transmits both the captured images of the fixed camera 15 and the pet camera 24, the owner can see the images of the objective view of the pet P and the pet's view at the same time, and can know the state of the pet P at that time in more detail. Incidentally, when the home terminal 10 transmits both the captured images of the fixed camera 15 and the pet camera 24, the home terminal 10 may transmit the images as a single still image synthesized by arranging two still images vertically or horizontally. While it depends on the messaging application operating on the user terminal 300, this allows two captured images to be easily displayed in a manner arranged vertically or horizontally on the user terminal 300.

(Image Transmission Processing)

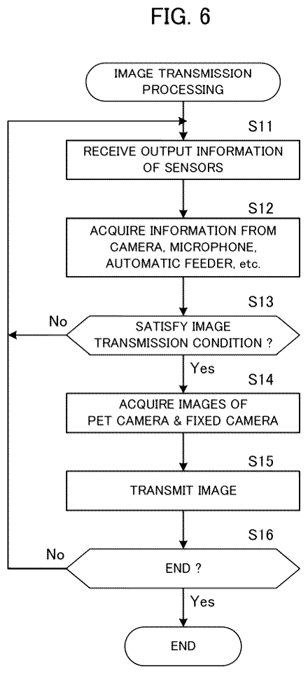

FIG. 6 is a flowchart illustrating image transmission processing executed by the server 200. This processing is realized by the processor 212 shown in FIG. 5 which executes a program prepared in advance.

First, the server 200 receives, from the home terminal 10, the output information of the sensors of the pet terminal 20 attached to the pet P (step S11). Also, the server 200 acquires information obtained by the fixed cameras 15, the microphone 16, the automatic feeder 17, and the pet toilet 18 installed in the home 5 from the home terminal 10 (step S12).

Next, the server 200 estimates the state of the pet P based on the in formation acquired in steps S11 and S12, and determines whether or not the state of the pet P satisfies a predetermined image transmission condition (step S13). When the state of the pet P does not satisfy the image transmission condition (step S13: No), the processing returns to step S11.

On the other hand, when the state of the pet P satisfies the image transmission condition (step S13: Yes), the server 200 acquires one or both of the captured images of the fixed camera 15 and the pet camera 24 at that time (step S14). The server 200 periodically receives the captured images of the fixed cameras 15 and the pet camera 24 and stores the images for a predetermined amount of time in the DB 215. The server 200 acquires the image at the time when the state of the pet P satisfies the image transmission condition from the images stored in the DB 215. At this time, the server 200 may acquire the image to be transmitted to the user terminal 300 based on the setting previously made by the owner. For example, when the owner has set to transmit both the still image of the fixed camera 15 and the still image of the pet camera 24 to the user terminal 300, the server 200 cuts out the still images of the fixed camera 15 and the pet camera 24 at the time when the image transmission condition is satisfied from the images stored in the DB 215. Then, the server 200 transmits the acquired images to the user terminal 300 (step S15). Thus, the image of the pet P is transmitted to the user terminal 300.

Next, the server 200 determines whether or not to end the image transmission processing (step S16). Normally, the owner operates the user terminal 300 to turn on the image transmission processing by the server 200 when he or she leaves home, and operates the user terminal 300 to turn off the image transmission processing when he or she comes home. Therefore, the image transmission processing continues until the owner turns off the image transmission processing, and when the owner turns off the image transmission processing (step S16: Yes), the image transmission processing ends.

(Example of Images to be Transmitted)

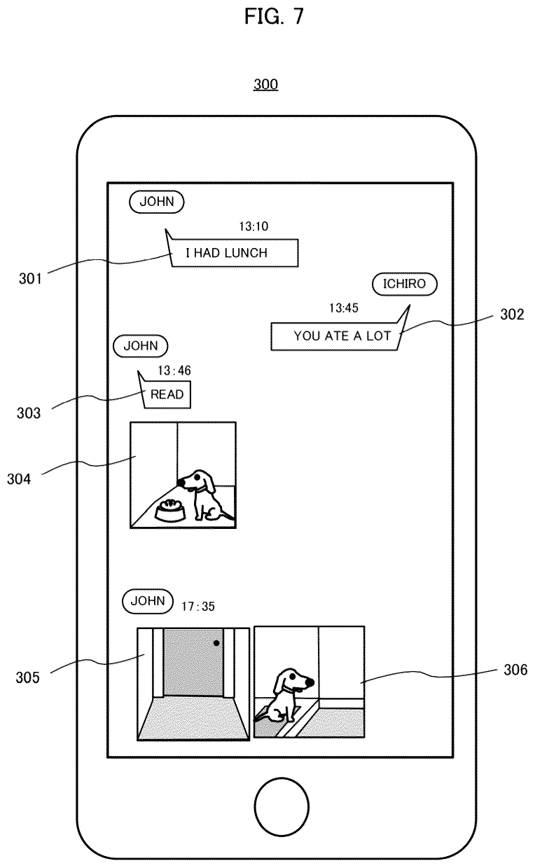

FIG. 7 shows a display example of the images transmitted by the image transmission processing. In this example, the user terminal 300 of the owner is displaying the message information and the images transmitted from the server 200 through the interactive SNS. It is assumed that the name of the owner is “Ichiro” and the name of the pet P is “John”. Also, in this example, it is assumed that the behavior of the pet P entering the dining space is not set as the image transmission condition, but set as the message information transmission condition, and that when the pet P finishes the meal, a message prepared in advance is transmitted to the user terminal 300. Therefore, as shown in FIG. 7, the messaging application of the user terminal 300 displays the text message 301 at 13:10, saying “I had lunch.” Also, the owner sees this text message and returns the text message 302 saying “You ate a lot.” Further, server 200 transmits a “read” message 303 for the message 302 and the image 304 of the pet P eating.

Also, in this example, it is assumed that the behavior of the pet P staying in the entrance for 5 minutes or more between 17:00 and 19:00 is set as the image transmission condition. In addition, it is assumed to be set that both still images of the fixed camera 15 and the pet camera 24 are transmitted. Therefore, as illustrated in FIG. 7, the messaging application of the user terminal 300 receives and displays the still image 305 of the pet camera 24 and the still image 306 of the fixed camera at 17:35.

[Modification]

(Modification 1)

In the first example embodiment described above, basically the information acquired by various devices and the pet terminal 20 installed in the home 5 are transmitted to the server 200 as they are, and the server 200 performs a state analysis or the like to determine the state of the pet P on the basis of the information received. Instead, a part of the processing for determining the state of the pet P may be performed in the home terminal 10 and the processing result may be transmitted to the server 200. For example, the feature value extraction or the like from the images may be performed on the home terminal 10 side, and the result may be transmitted to the server 200. This reduces the communication load from the home terminal 10 to the server 200 and the processing load on the server 200.

(Modification 2)

When the state of the pet P satisfies the image transmission condition and the image of the pet is transmitted to the user terminal 300, the server 200 may transmit the image according to the character of the owner, or the attribute or character of the pet. Further, when the state of the pet P satisfies the image transmission condition and the image of the pet is transmitted to the user terminal 300, the server 200 may transmit the message according to the character of the owner, or the attribute or character of the pet. In this case, the owner may set the type of the image and the specific message information in advance, for the image and message information according to the character of the owner and for the image and message information according to the attributes and character of the pet.

### Second Example Embodiment

In the first example embodiment described above, the information acquired by the various devices and the pet terminal 20 installed in the home 5 are transmitted to the server 200, and the server 200 transmits the image or message information of the pet P to the user terminal 300 based on the image transmission condition or the message information transmission condition. Alternatively, the function of the server 200 may be performed by the home terminal 10 of the home system. That is, the home terminal 10 determines whether or not the image transmission condition and the message information transmission conditions are satisfied based on the information outputted from the various devices and the pet terminal 20 installed in the home 5, and transmits the image and the message information of the pet P to the user terminal 300.

In this case, the interactive SNS messaging application is installed in the home terminal 10. When the home terminal 10 determines that the image transmission condition or the message information transmission condition is satisfied, the home terminal 10 sets the owner's user terminal 300 as the destination and transmits the image and/or the message information of the pet P using the messaging application. The image and/or the message information of the pet P are transmitted to the owner's user terminal 300 by the interactive SNS of the server 200. Incidentally, except for the above points, the second example embodiment is the same as the first example embodiment.

### Third Example Embodiment

In the above example embodiments, the images of the pet P transmitted to the user terminal 300 may be collected to create an image collection such as a digest album. For example, the images of the pet P transmitted to the user terminal 300 in a period specified by the owner, e.g., one day, one week, or the like are used to generate a digest album. Specifically, in the first example embodiment, the digest album may be generated by using the images transmitted by the server 200 to the user terminal 300. In the second example embodiment, the digest album may be generated by using the images transmitted by the home terminal 10 to the user terminal 300. In the first and second example embodiments, the user terminal 300 may have a function of collecting the received images of the pet P to create a digest album.

### Fourth Example Embodiment

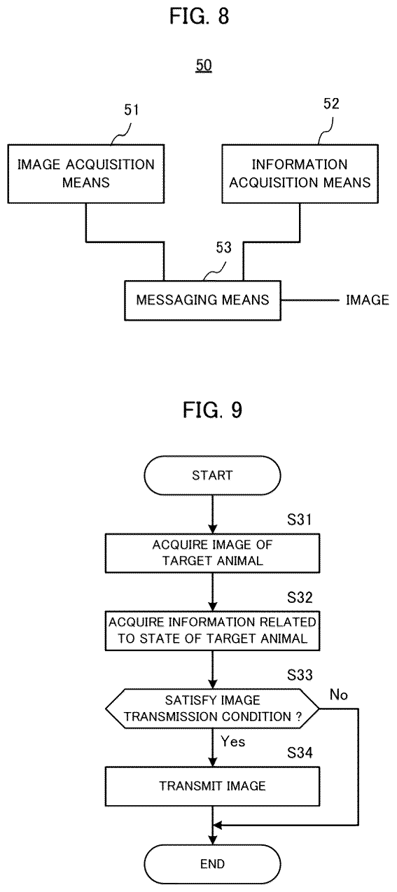

FIG. 8 is a block diagram illustrating a functional configuration of an information processing device according to a fourth example embodiment. The information processing device 50 according to the fourth example embodiment includes an image acquisition means 51, an information acquisition means 52, and a messaging means 53. The image acquisition means 51 acquires an image capturing a target animal. The information acquisition means 52 acquires information related to a state of the target animal. Then, the messaging means 53 transmits an image capturing the state of the target animal when the state of the target animal satisfies a predetermined image transmission condition, based on the image and the information.

FIG. 9 is a flowchart of processing performed by the information processing device 50. The image acquisition means 51 acquires an image capturing a target animal (step S31). The information acquisition means 52 acquires information related to a state of the target animal (step S32). Then, the messaging means 53 determines whether or not the state of the target animal satisfies a predetermined image transmission condition, based on the captured image and the acquired information. When the state of the target animal does not satisfy the predetermined image transmission condition (step S33: No), the processing ends. On the other hand, when the state of the target animal satisfies the predetermined image transmission condition (step S33: Yes), the messaging means 53 transmits the image capturing the state of the target animal (step S34).

According to the information processing device of the fourth example embodiment, since the image of the target animal when the target animal satisfies the predetermined image transmission condition is transmitted, the owner can confirm the state of the target animal in a specific state in the image. In addition, since the owner can communicate closely with a pet, the owner becomes fond of the pet, and it is also possible to prevent the pet from being abandoned.

A part or all of the example embodiments described above may also be described as the following supplementary notes, but not limited thereto.

(Supplementary note 1)

An information processing device comprising:
an image acquisition means configured to acquire an image capturing a target animal;
an information acquisition means configured to acquire information related to a state of the target animal; and
a messaging means configured to transmit an image capturing the state of the target animal when the state of the target animal satisfies a predetermined image transmission condition, based on the image and the information.

(Supplementary Note 2)

The information processing device according to Supplementary note 1,
wherein the image acquisition means acquires the image captured by a first camera attached to the target animal, and
wherein the messaging means transmits the image captured by the first camera.

(Supplementary Note 3)

The information processing device according to Supplementary note 2, wherein the first camera is set to shoot an area including a viewing direction of the target animal.

(Supplementary Note 4)

The information processing device according to any one of Supplementary notes 1 to 3, wherein the messaging means transmits the image to a terminal device of an owner via an interactive SNS.

(Supplementary Note 5)

The information processing device according to any one of Supplementary notes 1 to 4,
wherein the image acquisition means acquires the image captured by a second camera installed in a space where the target animal stays, and
wherein the messaging means transmits the image captured by the second camera.

(Supplementary Note 6)

The information processing device according to any one of Supplementary notes 1 to 5, wherein the image transmission condition includes that the target animal is in a predetermined place.

(Supplementary Note 7)

The information processing device according to Supplementary note 6, wherein the image transmission condition includes that the target animal is in the predetermined place for a predetermined time or more.

(Supplementary Note 8)

The information processing device according to Supplementary note 6 or 7, wherein the image transmission condition includes that the target animal is in the predetermined place in a predetermined time zone.

(Supplementary Note 9)

The information processing device according to any one of Supplementary notes 1 to 8, wherein the image transmission condition includes that the target animal has performed a predetermined behavior.

(Supplementary Note 10)

The information processing device according to Supplementary note 9, wherein the image transmission condition includes that the target animal repeatedly performs the predetermined behavior a predetermined number of times, or that the target animal continuously performs the predetermined behavior for a predetermined time or more.

(Supplementary Note 11)

The information processing device according to any one of Supplementary notes 1 to 10, wherein the image transmission condition includes that the target animal becomes a predetermined health state.

(Supplementary Note 12)

The information processing device according to any one of Supplementary notes 1 to 11, wherein the image transmission condition includes that the target animal becomes a predetermined mental state.

(Supplementary Note 13)

The information processing device according to any one of Supplementary notes 1 to 12, wherein the messaging means transmits message information prepared in advance, when the state of the target animal satisfies a predetermined message information transmission condition.

(Supplementary Note 14)

The information processing device according to Supplementary note 13, wherein the messaging means transmits the image corresponding to a message received via an interactive SNS when a content of the message received from a user terminal satisfies the image transmission condition, and transmits message information corresponding to the received message via the interactive SNS when the content of the received message satisfies the message information transmission condition.

(Supplementary Note 15)

The information processing device according to Supplementary note 14, wherein the messaging means transmits at least one of the message and the image according to a character of a user via the interactive SNS.

(Supplementary Note 16)

The information processing device according to Supplementary note 14, wherein the messaging means transmits at least one of the message and the image according to a character of a pet via the interactive SNS.

(Supplementary Note 17)

The information processing device according to any one of Supplementary notes 1 to 16, wherein the information acquisition means includes a sensor or a microphone attached to the target animal.

(Supplementary Note 18)

An information processing method comprising:
acquiring an image capturing a target animal;
acquiring information related to a state of the target animal; and
transmitting an image capturing the state of the target animal when the state of the target animal satisfies a predetermined image transmission condition, based on the image and the information.

(Supplementary Note 19)

A recording medium recording a program, the program causing a computer to execute processing comprising:
acquiring an image capturing a target animal;
acquiring information related to a state of the target animal; and
transmitting an image capturing the state of the target animal when the state of the target animal satisfies a predetermined image transmission condition, based on the image and the information.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

10 Home terminal
15 Fixed camera
16 Microphone
17 Automatic feeder
18 Pet toilet
19 Speaker
20 Pet terminal
24 Pet camera
27 Biological sensor
100 Home system
200 Server
300 User terminal

What is claimed is:

1. An information processing device comprising:
a memory configured to store instructions; and
one or more processors configured to execute the instructions to:
acquire an image capturing a target animal;
acquire information related to a state of the target animal; and
transmit an image capturing the state of the target animal when the state of the target animal satisfies a predetermined image transmission condition, based on the image and the information.

2. The information processing device according to claim 1,
wherein the one or more processors acquire the image captured by a first camera attached to the target animal, and
wherein the one or more processors transmit the image captured by the first camera.

3. The information processing device according to claim 2, wherein the first camera is set to shoot an area including a viewing direction of the target animal.

4. The information processing device according to claim 1, wherein the one or more processors transmit the image to a terminal device of an owner via an interactive SNS.

5. The information processing device according to claim 1,
wherein the one or more processors acquire the image captured by a second camera installed in a space where the target animal stays, and
wherein the one or more processors transmit the image captured by the second camera.

6. The information processing device according to claim 1, wherein the image transmission condition includes that the target animal is in a predetermined place.

7. The information processing device according to claim 6, wherein the image transmission condition includes that the target animal is in the predetermined place for a predetermined time or more.

8. The information processing device according to claim 1, wherein the image transmission condition includes that the target animal is in the predetermined place in a predetermined time zone.

9. The information processing device according to claim 1, wherein the image transmission condition includes that the target animal has performed a predetermined behavior.

10. The information processing device according to claim 9, wherein the image transmission condition includes that the target animal repeatedly performs the predetermined behavior a predetermined number of times, or that the target animal continuously performs the predetermined behavior for a predetermined time or more.

11. The information processing device according to claim 1, wherein the image transmission condition includes that the target animal becomes a predetermined health state.

12. The information processing device according to claim 1, wherein the image transmission condition includes that the target animal becomes a predetermined mental state.

13. The information processing device according to claim 1, wherein the one or more processors transmit moans transmits message information prepared in advance, when the state of the target animal satisfies a predetermined message information transmission condition.

14. The information processing device according to claim 13, wherein the one or more processors transmit the image corresponding to a message received via an interactive SNS when a content of the message received from a user terminal satisfies the image transmission condition, and transmit its message information corresponding to the received message via the interactive SNS when the content of the received message satisfies the message information transmission condition.

15. The information processing device according to claim 14, wherein the one or more processors transmit at least one of the message and the image according to a character of a user via the interactive SNS.

16. The information processing device according to claim 14, wherein the one or more processors transmit at least one of the message and the image according to a character of the target animal via the interactive SNS.

17. The information processing device according to claim 1, wherein the one or more processors acquire the information related to the state of the target animal by a sensor or a microphone attached to the target animal.

18. An information processing method comprising:
acquiring an image capturing a target animal;
acquiring information related to a state of the target animal; and
transmitting an image capturing the state of the target animal when the state of the target animal satisfies a predetermined image transmission condition, based on the image and the information.

19. A non-transitory computer-readable recording medium recording a program, the program causing a computer to execute processing comprising:
acquiring an image capturing a target animal;
acquiring information related to a state of the target animal; and
transmitting an image capturing the state of the target animal when the state of the target animal satisfies a predetermined image transmission condition, based on the image and the information.
